(19) United States
(12) Patent Application Publication
(10) Pub. No.: US 2017/0270628 A1
(43) Pub. Date: Sep. 21, 2017

(54) SYSTEM AND METHODS FOR ANALYZING INFORMATION FROM IDENTIFICATION DOCUMENTS

(71) Applicant: Intellicheck Mobilisa, Inc., Jericho, NY (US)

(72) Inventors: William H. Roof, Port Townsend, WA (US); Russell T. Embry, New York, NY (US)

(21) Appl. No.: 15/612,199

(22) Filed: Jun. 2, 2017

Related U.S. Application Data
(63) Continuation of application No. 15/043,182, filed on Feb. 12, 2016.

(51) Int. Cl. G06Q 50/26; G06K 9/00; G06F 17/30

(52) U.S. Cl. CPC G06Q 50/26; G06F 17/30477; G06K 9/00577; G06K 9/00469

(57) ABSTRACT

A system and methods for analyzing information from identification documents is disclosed. The system initially scans or retrieves identification information from an identification document associated with an individual or an item. The system then receives an indication of a search strategy for the received information. The search strategy indicates an identity of databases that are to be searched. The system then determines a query format of a database where the system can perform a search associated with the identification document. The system generates a query based on the determined query format and transmits the query to the database. The system receives a search result from the database and analyzes the search result. The analyzed search result is transmitted to a user device and is presented as an alert to a user. The alert includes a threat level of the individual or a status of the item.

### CROSS-REFERENCE TO RELATED APPLICATION(S)

This application is a continuation of U.S. patent application Ser. No. 15/043,182 entitled “SYSTEM AND METHODS FOR ANALYZING INFORMATION FROM IDENTIFICATION DOCUMENTS” filed on Feb. 12, 2016, the disclosure of which is incorporated herein by reference in its entirety.

### BACKGROUND

Identity verification is critical for field operators, such as police officers or security officers, during their routine operations. Field operators need to check and authenticate identification documents, and verify the identities of individuals in a safe and efficient way while maintaining their attention on the individuals. In a traditional fashion, a field operator will typically bring an identification document associated with an individual to a computer (such as a computer installed in a police vehicle or at a security station) and manually input the data from the identification document into the computer. The computer submits entered information to a dispatcher who then performs queries to find information about the individual. The results of the queries are returned to the field operator in order to provide the field operator with information that can be used to verify the individual's identity and information that is noteworthy about the individual, for example, wants, warrants and criminal history, among many data sets that would be important to the authorities. The field operator making the contact may also request information on the individual via radio. In this situation, the field operator requesting information may need to create distance from the individual to ensure the individual does not hear the radio response. Unfortunately, manual entry of the information by the field operator, availability of dispatch personnel to process requests, and manual review by the field operator of any resulting information can be a time-consuming and inefficient process. Keying errors or compiling errors by field operator and dispatcher can introduce inaccuracies in the analysis. In addition, bringing the identification document to the computer diverts, at least to some extent, the field operator's attention from the individual and increases the time between initial contact and query response. This increased time period poses a potential threat to the field operator requesting information.

One way to overcome the problems with manual identification checks is to utilize an automatic scanning system that can quickly scan and accurately verify an identification document. One downside of these automatic scanning systems is that they may require a field operator to operate with both hands. Another disadvantage is that the whole verification process performed by these automatic scanning systems can take a long time. Yet another drawback is that these automatic scanning systems can only search a local database (e.g., a local police department wanted suspect list). Still another downside of these automatic scanning systems is that they fail to provide a field operator with sufficient information to support his/her further action in a timely manner. Also, even with automatic scanning systems, a field operator still needs to manually record or collect information that can be used for an incident report, which can sometimes be troublesome and time-consuming.

### BRIEF DESCRIPTION OF THE DRAWINGS

FIG. 1A is a schematic diagram illustrating a system for analyzing information derived from an identification document associated with an individual.

FIG. 1B is a schematic diagram illustrating another system for analyzing information derived from an identification document associated with an individual.

FIG. 2A is a screenshot illustrating a user interface that shows the status of databases being searched. The user interface also enables the field operator to view an authenticity verification result of an identification document.

FIGS. 2B and 2C are screenshots illustrating user interfaces showing results of an authenticity check for an identification document.

FIGS. 2D and 2E are screenshots illustrating user interfaces showing results of a search in one or more databases.

FIG. 2F is a schematic diagram illustrating user interfaces showing how a field operator can review a search result.

FIG. 3A a schematic diagram illustrating an embodiment of an incident report associated with an incident.

FIG. 3B is a screenshot illustrating another embodiment of the incident report.

FIG. 4A is a screenshot illustrating a user interface for a field operator to set a role.

FIG. 4B is a screenshot illustrating a user interface for a field operator to set the list order of databases and list order of session start categories.

FIG. 5 is a flowchart illustrating a method implemented by a query server. The query server analyzes information derived from an identification document via an identification scanning system and sequentially provides the results to the identification scanning system.

FIG. 6 is a flowchart illustrating a method implemented by an identification scanning system. The system analyzes information derived from an identification document and sequentially presents an alert to a user based on an analyzed result.

### DETAILED DESCRIPTION

Identity verification plays an important role in various field operations such as law enforcement operations. Before taking any action, a field operator needs to check and verify the identity of an individual standing in front of him/her and to know his/her threat level (e.g., dangerous, wanted, normal, etc.) in a timely manner. In addition, it is advantageous to allow the field operator to perform such identity verification tasks without interfering with the field operator's routine operation (e.g., without requiring a field operator to carry additional equipment or devices).

The present system and methods provide an effective and convenient way to verify the identity of an identification document holder in a timely manner. The present system and methods provide a proper alert to a field operator (e.g., a police officer, a private investigator, a security guard, etc.) of the threat level of the identification document holder.

In addition to verifying the identity of an individual, the present system can also verify the identity of an item, such as a vehicle or firearm, after collecting item-related information. Based on the collected information, the present system can perform a search and analyze the search result, so as to provide useful information relating to the item (e.g., a firearm is “reported missing”; a vehicle is “to be seized”) to a field operator. In some embodiments, the item-related information can be collected by scanning related item identification documents such as a vehicle registration or a firearm license. In other embodiments, the system receives the item-related information by manual input. In some embodiments, the item-related information can be collected by directly scanning related items (e.g., capturing an image of a license plate; an image of a gun) and then using optical character recognition (OCR) technologies to detect text present in the image (e.g., the serial number on the gun; the license plate number).

More particularly, the present system and methods enable: (1) scanning or retrieving identification information derived from identification documents (including personal identification documents or item identification documents) or from images of items; (2) generating one or more queries for one or more suitable databases according to a search strategy; (3) performing a search, based on a pre-determined search strategy, in the suitable databases based on the queries; (4) forming a search result; (5) analyzing the search result; and (6) presenting the analyzed search result as a simplified alert (e.g., as a red area shown on a display to indicate that the identification document holder is a wanted suspect) to a field operator in a timely manner (e.g., within 5 seconds, depending on the data transmission speed) so as to facilitate the field operator to make a decision of taking further action (e.g., arrest the identification document holder or seize the item) in response to the alert.

One feature of the system is that it performs a thorough background search for the identification document holder or the item by searching multiple available databases. Various databases can have different data structures and security mechanisms. Accessing these databases may require different query formats or syntaxes. The present system and methods provide a quick and convenient way for a field operator to perform a search in multiple databases.

Another aspect of the system is that a search result can be presented in an easily-understandable, straightforward manner to a field operator. For example, the search result can be presented as a simple visual, audible, or tactile alert that quickly provides the user with an assessment of the relative risk of the individual associated with the identification document or item. The alert can include a threat level of the identification document holder or a current status of the item (such as “reported missing”) along with a recommendation of the field operator's next action (e.g., arrest the identification document holder or seize the item). Visual alerts may be, for example, a colored light or a graphic icon shown on a display. Audible alerts may be a tone or other sound played through a speaker or through an earpiece. Tactile alerts may be a distinctive vibration of a wearable item by the field operator. Whether visual, audible, or tactile, an alert can be “secretly” presented to the field operator. By doing so, the system enables the field operator to take proper action without alerting the identification document holder.

The system may be contained in an integrated device, such as a scanning device that can search various online or local databases. Alternatively, the system can be distributed across multiple devices connected via communication links. For example, a portable scanning/displaying device to be used in the field can be responsible for scanning an identification document and displaying an alert to a field operator. Meanwhile, a remote query server in communication with the portable device can be responsible for performing a search in various databases.

Another aspect of the system is that it can be implemented in conjunction with existing devices that might already be carried by a field operator, such as a mobile device (e.g., a smartphone). In such embodiments, the field operator does not need to carry additional devices to access the disclosed features. Accordingly, the field operator's daily operation is not significantly interfered or burdened. When implemented on existing devices, the system is typically provided as a suitable software product for installation on mobile devices like smart phones or tablets.

In some embodiments, the system disclosed herein can maintain a record or generate a report describing an “incident.” The incident can be, for example, an event in which a field operator (1) verifies an identification document associated with an individual, (2) performs a search, based on a pre-determined search strategy, in various databases, and (3) arrests the individual. The incident report can include, for example, a description of the incident (e.g., why the field operator initiated the identification verification process), an incident category (e.g., an auto vehicle theft investigation, a stop-and-frisk event, etc.), a recommended action (e.g., arrest the individual, collect evidence, etc.), an incident resolution (e.g., how the field operator actually acts), comments/notes, related images/audio files (e.g., scene pictures or audio recordings), time/locations, related queries in various databases, an incident map (e.g., a map visually presenting where the incident happens), etc. The incident report can be in any format that is in compliance with a field operator's current role. For example, the incident report can be in the same format as a police report. By generating an incident report, the system can save a field officer's time preparing reports. The incident reports can be automatically and periodically uploaded to a centralized database for record keeping.

Various embodiments of the system will be described below. The following description provides specific details for a thorough understanding and an enabling description of these embodiments. One skilled in the art will understand, however, that the system may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the system.

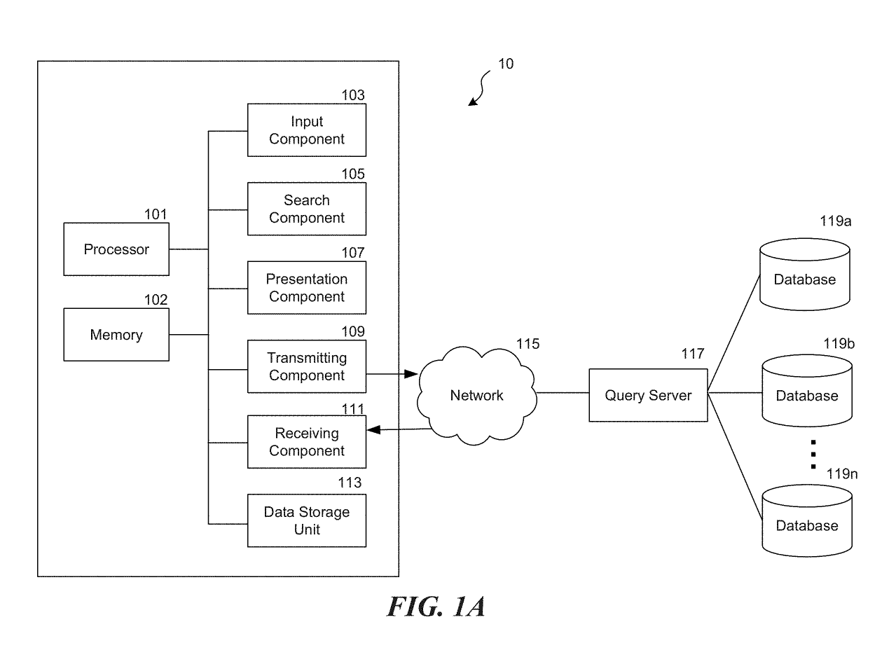

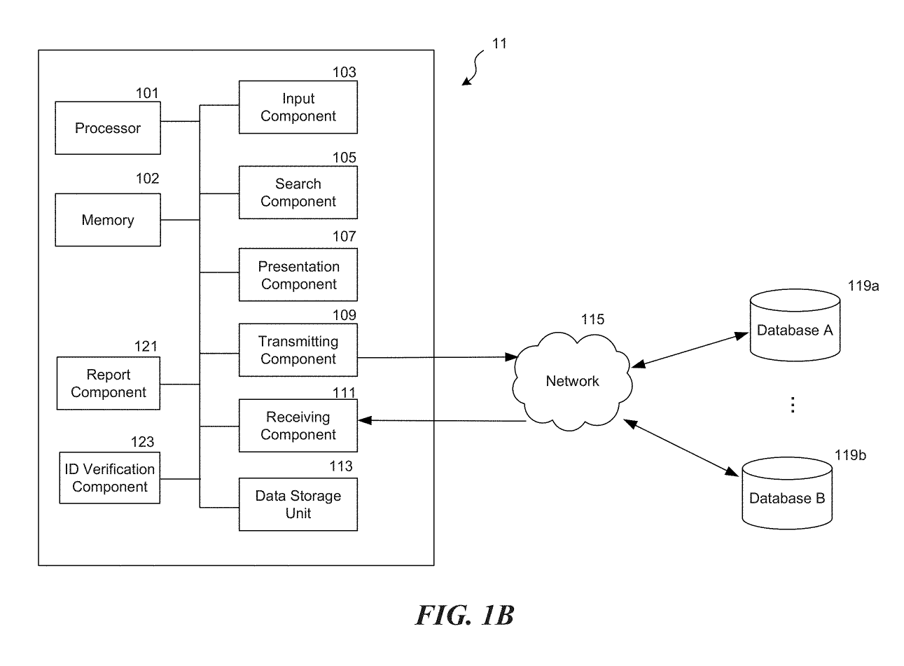

FIG. 1A is a schematic diagram illustrating a system 10 for analyzing information derived from an identification document associated with an individual. The identification document can be a local government-issued identification document (e.g., a driver's license, a state identification, etc.), a federal government-issued identification document (e.g., a passport, a military identification, etc.), a non-government-issued identification document (e.g., a corporate identification, a school identification, etc.), or other suitable identification documents. The identification information can be encapsulated, embedded, or reflected in the identification document by visible text, barcodes, magnetic stripes, embedded data chips, etc. that are printed on, attached to, or contained in the identification document. The identification information is read from the identification document using a complementary technology (e.g., bar code or magnetic stripe reader, wireless reader, etc.).

As shown in FIG. 1A, the system 10 communicates with a query server 117 via a network 115. The query server 117 can further communicate with one or more databases 119a, 119b, . . . 119n via a secured or unsecured connection. In some embodiments, the network 115 can include the Internet, an intranet, a wireless network, or other suitable networks. In some embodiments, the query server 117 can communicate with the databases 119a, 119b, . . . 119n via the network 115 as well. The databases store information associated with personal identities or property identities (such as a vehicle registration). Examples of the databases include the National Crime Information Center (NCIC) database, state law enforcement department databases, local (e.g., county, city, etc.) police department (PD) databases, the Department of Motor Vehicles (DMV) database, the Department of License (DOL) database, social network databases, social media databases, etc. Each database can be a distributed database or a centralized one.

In some embodiments, the system 10 can be a mobile device (e.g., a smartphone, a notebook, a tablet, a phablet, an identification scanner, or other suitable devices). The system 10 and the query server 117 can together (1) retrieve information from the identification document; (2) perform a search in one or more databases based on a pre-determined search strategy and the retrieved information to generate search results; (3) analyze the search results; (4) generate an alert or an all-clear signal to the field operator based on the search results; and (5) present the alert or the all-clear signal to a field operator with one or more recommended actions. The predetermined search strategy is a set of rules that describes how a search (or multiple searches) should be performed. In some embodiments, the predetermined search strategy can include: (1) the type of searches to be performed (e.g., a personal search, a firearm search, an automobile search); (2) the number and identity of databases to be searched; (3) rules for analyzing search results; and/or (4) rules for presenting the search results. A personal search is a search associated with the identity of an individual. For example, a personal search can be initiated by scanning a driver's license provided by an individual who requests access to a facility or has been pulled over for speeding. An item search is a search associated with the identity of an item. For example, an item search can be initiated by scanning a title, license registration, or insurance document associated with an automobile. In some embodiments, an item search can be initiated by taking a picture of an item and detecting any text in the picture using OCR technologies. In other embodiments, an item search can be initiated by a manual input of a serial number associated with an item.

As shown in FIG. 1A, the system 10 includes a processor 101, a memory 102, an input component 103, a search component 105, a presentation component 107 (e.g., a display screen, speaker, haptic generator, etc.), a transmitting component 109, a receiving component 111, and a data storage unit 113. The processor 101 is coupled to other components and configured to control the same. The memory 102 is configured to temporarily (or non-transitorily) store data or instructions that are processed by the processor 101.

During a typical operation, a field operator of the system 10 encounters an individual and would like to verify or check the identity of that individual. After obtaining an identification document from the encountered individual, the field operator uses the system 10 to scan, read, or enter identification information from the identification document presented by the individual. That is, the system may be used to scan the identification document (e.g., using a barcode or magnetic-stripe reader) and/or to manually enter related information from the identification document or encounter.

More particularly, the input component 103 of the system 10 is utilized to retrieve information from the identification document by scanning or manual entry. In some embodiments, the input component 103 includes a scanning device. The scanning device can retrieve the identification information via image capture and optical character recognition (OCR), barcode reader, magnetic stripe reader, wireless sensor (e.g., RFID) reader, or other suitable technologies. Additional details about techniques for scanning identification documents are described in commonly-owned U.S. Pat. No. 5,864,623, filed on Jul. 15, 1996 and entitled, “AUTHENTICATION SYSTEM FOR DRIVERS LICENSES” and U.S. Pat. No. 8,322,605, filed on Aug. 22, 2007 and entitled, “DYNAMIC IDENTITY MATCHING IN RESPONSE TO THREAT LEVELS,” which are incorporated by reference herein in their entirety. For example, the input component 103 can be a camera installed in a smartphone carried by a field operator. In various embodiments, the input component 103 can also receive a user input (e.g., information manually input through a virtual or physical keyboard, or audibly using speech-to-text processing).

In some embodiments, the system retrieves item-related information by scanning related item identification documents such as a vehicle registration or a firearm license. After capturing an image of the document, for example, the system 10 uses barcode recognition technologies to extract the encoded information within the barcode or use OCR technologies to analyze the image and convert the image into text for further analysis. Once converted into text, the system 10 uses semantic analysis or pattern-recognition technologies in order to identify data having a certain format. For example, a vehicle registration will contain a VIN number of a vehicle, or a firearm license may contain a registration number that is of a known format and content. Using such an analysis methodology, the system 10 identifies item description information that can be used in search queries pertaining to the associated item. In some embodiments, the system 10 can retrieve item-related information by capturing and analyzing images related to the item. For example, the field operator can use the system to take a picture of an item with a serial number thereon, or the picture of an item that contains a barcode. The system 10 then analyzes the picture in order to detect the identifying information contained on the item. For example, the system may use OCR technology to detect text that is contained in the picture, or the system may use barcode interpretation software to read and interpret a bar code that is reflected in the picture.

In some embodiments, when the retrieved information does not provide a sufficient basis for the system 10 to perform desired queries, the system can send a request for further information to an operator. For example, a query associated with a personal search may require an individual's social security number, which cannot be retrieved from a driver's license. In such cases, the system 10 can display a dialogue box asking the system operator to manually input the individual's social security number.

After the information from the identification document is retrieved, the search component 105 either selects or allows a field operator to specify a search strategy that is to be applied related to the retrieved or scanned information. Generally speaking, the system 10 enables a field operator to perform different types of searches, such as a personal search (e.g., search criminal records related to a person in various databases), and an item search (e.g., search a vehicle in the DMV database; search a gun in a firearm database; search a drug in a controlled-substance database). In some embodiments, a personal search can include an activity search associated with a person (e.g., search for a specific type of criminal conduct or a suspected terrorist activity in a person's social network profile). The search component 105 therefore determines what search strategy is to be followed and builds an appropriate search query (or multiple queries) to send to the query server(s) based on the selected search strategy. The search query specifies the search that is to be performed, including the databases to be searched and, in some cases, how the search results from the databases are to be analyzed. Moreover, the search query also provides any scanned or entered information necessary to implement the search strategy. In some embodiments, the search component 105 suggests a search strategy to a field operator based on a user's query (e.g., a query relating to a vehicle, a person, a location, or a criminal activity). In other embodiments, the search strategy is specified by the field operator without a recommendation from the search component 105. For example, the field operator can choose to search the DMV database only. As another example, the field operator can decide to search certain databases (e.g., due to personal preference, or to avoid generating additional search expenses for certain databases). In other cases, the search strategy is pre-determined by the search component 105. That is, the search component applies a pre-configured search strategy that is stored in the data storage unit 113.

In some embodiments, the applied search strategy and the databases that are accessed by the system will depend on a “role” of the field operator. For example, the field operator may be a private investigator who is hired to investigate an automobile theft case. In that case, the field operator can set the default search strategy as a type of item search, namely a vehicle search based on a license plate number or a Vehicle Identification Number. Based on the selected search strategy, the system 10 generates a search query using either default settings (e.g., by automatically performing an item search in both the DMV database and the NCIC database) or using custom settings selected by the field operator (e.g., by performing an item search in only the DMV database). As another example, the field operator can be a federal agent who is primarily responsible for federal crime investigations. In that case, the field operator can set the default search strategy as a personal search, namely a suspect search in criminal record databases relating to federal crimes. Based on the selected search strategy, the system 10 generates a search query using either default settings (e.g., by automatically performing a personal search in all available databases) or using custom settings selected by the field operator (e.g., by performing a personal search only in the DMV database or the NCIC database). As yet another example, the field operator can be a special agent responsible for preventing potential terrorist attacks. In that case, the field operator can set the default search strategy as a personal search (e.g., as a terrorist search). Based on the selected search strategy, the system 10 generates a corresponding search query using either default settings (e.g., by performing a personal search in the NCIC database, several social media databases, a terrorist-watch-list database, etc.) or using custom settings selected by the field operator (e.g., in a social network database to see if there are any leads relating to the retrieved identification information). For instance, the retrieved identification information may be associated with an existing social network account (e.g., by name matching or image matching) that includes a statement of unlawful conduct or a plan to commit a crime.

When the search strategy is determined, the search component 105 of the system 10 can then transmit some or all of the retrieved information and the search strategy to the query server 117 through the transmitting component 109. As shown in FIG. 1A and discussed above, the system 10 communicates with the query server 117 via the network 115. The query server 117 is configured to perform a search for the system 10. More specifically, the query server 117 can generate suitable queries in a query format required by each of the databases 119a, 119b, . . . 119n that is being accessed. The query server 117 then transmits one or more queries (in the proper query format) to certain databases so as to perform a search therein. A database that receives a search query will generate one or more responsive search results and returns the result to the query server 117. In some embodiments, the query server 117 first authenticates the request from the search component 105 before transmitting queries to databases. By authenticating each request, the query server ensures that only authorized users are able to submit queries to sensitive databases, such as a police database.

In a typical operation, the system then analyzes the returned search results. As will be described in additional detail herein, the analysis can include: (1) summarizing the search results; and (2) calculating a score associated with the search results and using the score to assess the threat level. A score may be calculated for the search results by performing a search for different keywords in the search results and adding different point values for each keyword that is identified. In order to calculate scores, the system maintains a table or other data structure that correlates certain keywords with certain point values. For example, identifying the keyword “homicide” in the search results can result in 10 score points; identifying the keywords “traffic violation” in the search results can result in 2 score points; and identifying the keyword “wanted” in the search results can result in 50 score points. After each keyword is identified and the corresponding point value determined, the resulting point values are summed together. The system can then define various threat levels based on the calculated score and provide corresponding recommended actions. For example, a score between 0-5 means “no record” or “not dangerous,” a score between 10-50 means “suspect,” and a score of 50 or above means “dangerous.” For cases with the “no record” or “not dangerous” analyzed result, the recommended action can be “keep records only” or “do nothing.” For cases with the “suspect” analyzed result, the recommended action can be “detain the individual for further investigation” or “collect further evidence.” For cases with the “dangerous” analyzed result, the recommended action can be “arrest the individual immediately.”

In some embodiments, the query server 117 analyzes the search results and generates the analyzed result. The query server 117 then transmits the analyzed result to the system 10 (e.g., through the receiving component 111 of the system 10) for further processing. For example, the system may generate an alert and present the alert to the field operator, as discussed in detail below. In other embodiments, however, the search results can be analyzed by the search component 105 of the system 10. In such embodiments, the query server 117 transmits the search results to the system 10, and the search component 105 directly generates the analyzed result.

After generation of the analyzed result, the system 10 determines the type of alert to present based on the analyzed result. The alert is indicative of a threat level (e.g., dangerous, wanted, suspect, normal or no threat, etc.) of the individual. The alert is preferably an easily-understandable and straightforward signal to the field operator. The alert thereby can quickly and effectively signify to the field operator the threat level of the identification document holder. The alert can also convey a recommendation to the field operator of his/her next action in response to the scan and the analysis of the identification document. In some embodiments, the alert is generated by the search component 105 of the system 10. When the analyzed result indicates that there is limited or no threat, the system 10 can generate an all-clear alert (e.g., a green light) reflecting the analysis results. In some embodiments, the alert can be generated based on a status of an item in question (e.g., auto, boat, gun, etc.). For example, the alert can indicate that the item in question has been reported stolen.

Once the form of the alert has been determined, the presentation component 107 of the system 10 presents the alert to the field operator. The alert can be presented as a visual signal, an audio sound, a tactile notification, or any combination thereof. As an example, the alert can be presented as a colored icon in a specified area on a display of the system 10. In some embodiments, various colors displayed in the specified area can represent different levels of threat. For example, a green signal in an area indicates that the identification document holder has no record and is presumably safe; a yellow signal in the same area indicates that the search is still in progress and thus the current status is unknown; and a red signal in the same area indicates that the individual is dangerous or wanted. In some embodiments, other colors may be used by the system to convey more nuanced information about the individual. For example, the color pink may be used to indicate that the individual is suspect but not dangerous (e.g., has only traffic violations but no criminal charges). In some embodiments, while the search is pending, the system may display either no icon or may display an icon that reflects the pending search (e.g., a blinking orange display).

In various embodiments, the alert can include various visual cues that help an operator more quickly process the displayed information. For example, the presented information may be blinking or flashing, may be displayed with different shapes reflecting the seriousness of the alert, may be presented in different colors or patterns, etc. In some embodiments, the severity of the alert can be indicated based on the displayed location. For example, a light signal at a corner of a display can mean “dangerous,” while the same signal showing in the center of the display can mean “normal.”

In some embodiments, the alert can be presented to the field operator in an audible fashion (e.g., through an earpiece or speaker) or tactile fashion (e.g., by vibration of a wearable item). For example, the alert can be a synthesized warning voice that is transmitted to the field operator through an earpiece. As another example, the alert can be different patterns of vibration of a watch worn by the field operator.

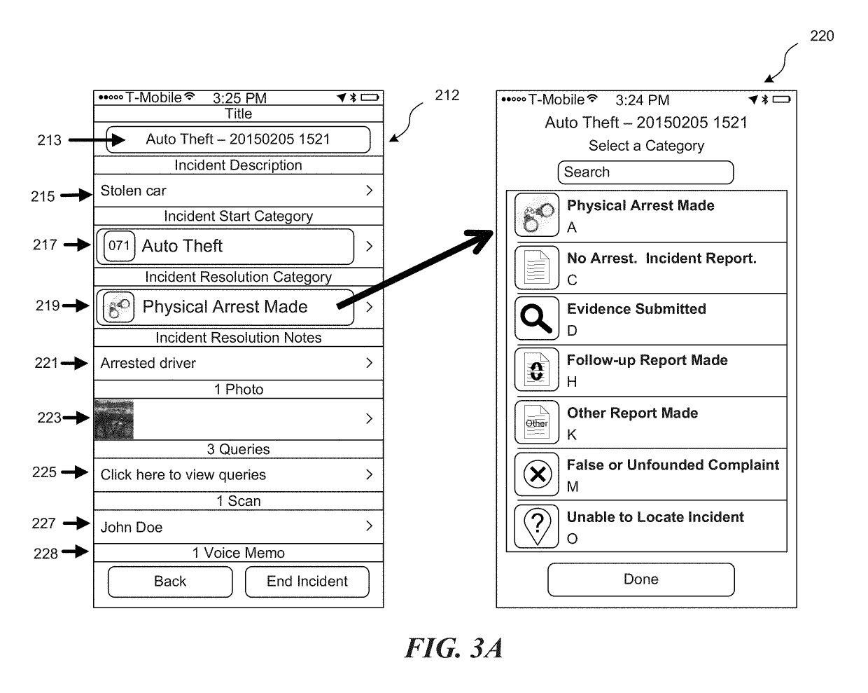

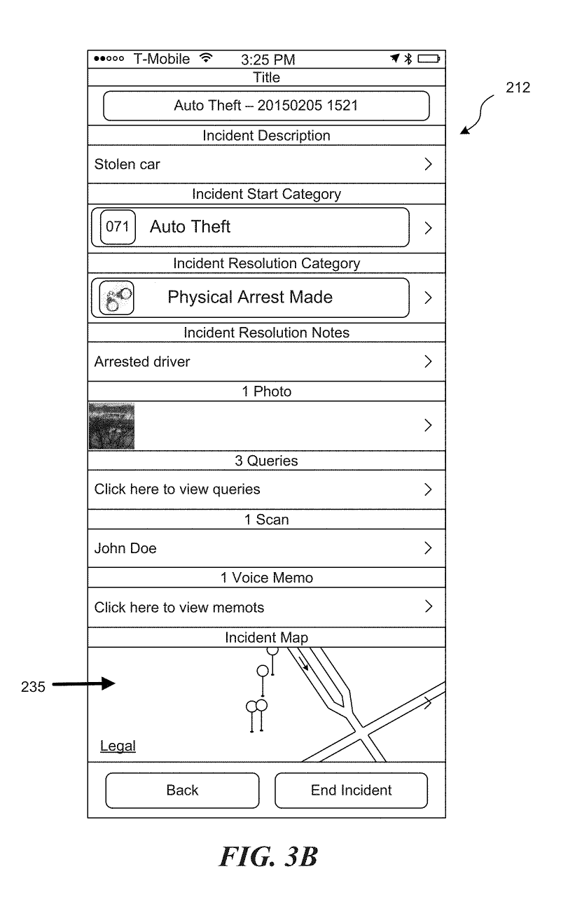

In some embodiments, the search component 105 also generates a record or an incident report for each processing step and result performed by the system 10. For example, the incident report may include a date/time code and descriptive information associated with the document scan, the searching performed, and the alert generated by the system. Examples of an incident report can be found in FIGS. 3A and 3B.

In some embodiments, the search component 105 can also be configured to verify the authenticity of the identification document. Additional details about techniques for verifying identification documents are described in commonly-owned U.S. Pat. No. 5,864,623, filed on Jul. 15, 1996 and entitled, “AUTHENTICATION SYSTEM FOR DRIVERS LICENSES,” U.S. Pat. No. 8,322,605, filed on Aug. 22, 2007 and entitled, “DYNAMIC IDENTITY MATCHING IN RESPONSE TO THREAT LEVELS,” U.S. Pat. No. 7,860,318, filed on Nov. 9, 2004 and entitled, “SYSTEM AND METHOD FOR COMPARING DOCUMENTS,” and U.S. Pat. No. 7,708,189, filed on May 16, 2003 and entitled, “IDENTIFICATION VERIFICATION SYSTEM AND METHOD,” which are incorporated by reference herein in their entirety. For example, the search component 105 can check the formats/content of the presented identification document and verify it by communicating with an internal database (e.g., information stored in the data storage unit 113) or an external database (e.g., the databases 119a, 119b, . . . 199n, through the query server 117).

In some embodiments, the data storage unit 113 is configured to store, permanently or temporarily, retrieved information, search results, analyzed search results, alerts, and/or generated incident reports. In several embodiments, the data storage unit 113 is configured to store information that can be used to verify the authenticity of the identification documents. In various embodiments, the data storage unit 113 is configured to store information that can be used to perform a local search. By storing information on the device itself, the system 10 is able to function normally even without a network connection.

To summarize, after the field operator scans the identification documents (or inputs the identification information), the system 10 promptly provides the field operator with an alert that signifies a threat level of the individual and a recommended action. The speed that the alert is generated by the system is dependent on the data transmission speed, the response time of queried databases, and/or the speed at which the resulting data is analyzed. As a result, the system 10 can effectively assist the field operator during his/her field operation by providing timely information with a recommended action. With the assistance of the system 10, the field operator can be more focused on other tasks (e.g., searching for evidence) and can pay more attention to suspects during the interaction. Accordingly, the system 10 can improve the efficiency and safety of the field operator's routine operations.

FIG. 1B is a schematic diagram illustrating another system 11 for analyzing information derived from an identification document associated with an individual. The system 11 functions similarly to the system 10 as discussed above. More specifically, the system 11 includes components with similar functions as those discussed with reference to FIG. 1A, but with certain distinguishing features. One distinguishing feature between the system 10 and the system 11 is that the system 11 can directly communicate with multiple databases (such as databases 119a and 119b) via the network 115 without relying upon an intermediate query server 117 to receive information and formulate search queries.

In addition, the search component 105 of system 11 can also be configured to (1) generate suitable queries for the multiple databases based on a search strategy; (2) communicate (e.g., via the transmitting component 109) with the multiple databases to perform a search; (3) receive (e.g., via the receiving component 111) search results from the multiple databases; (4) analyze the search results to form an analyzed result; and (5) transmit the analyzed result to the presentation component 107 so as to generate an alert. By this arrangement, the system 11 can provide a field operator with alerts regarding a threat level of a suspect and a recommended action in a timely manner without reliance upon a query server 117.

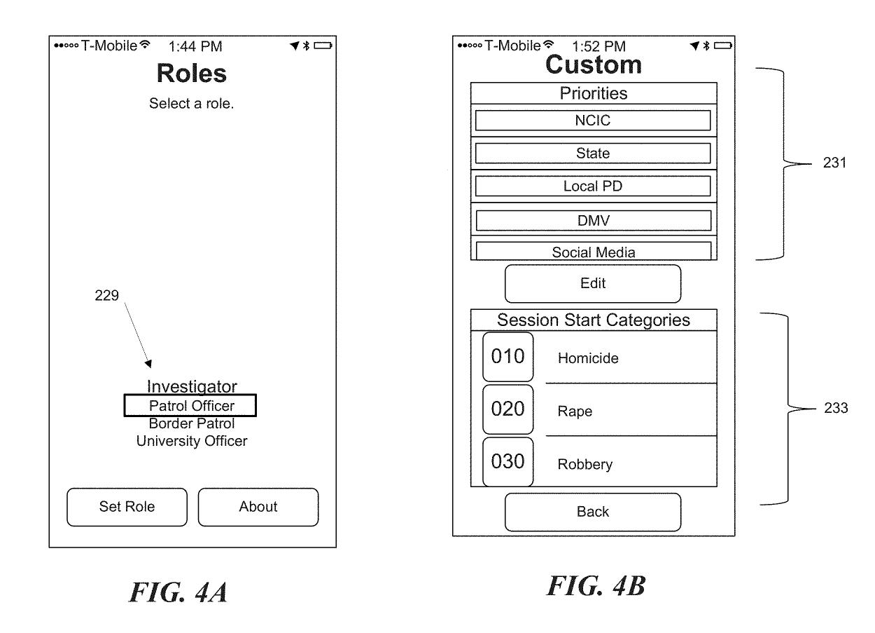

Another distinguishing feature of system 11 is that the search component 105 can be configured to prioritize the databases (e.g., to decide which database is a preferred database based on the search strategy of a field operator, or to decide an order of displaying search results from multiple databases; see FIG. 4B and relevant description below). In some embodiments, the priorities of the multiple databases can be determined based on a role of the field operator. For example, for a patrol officer primarily responsible for automobile theft investigations, he/she can assign higher priority to the DMV database.

Yet another distinguishing feature of system 11 is that it includes a report component 121. The report component 121 generates an incident report, examples of which are described herein with respect to FIGS. 3A and 3B. The incident report can include the following content: (1) an incident title/description; (2) the time/location/details of an identification document scan or check; (3) the context in which the scan or check is initiated (e.g., a stolen car investigation decided by a field operator); (4) a record of the queries associated with one or more databases and/or the search results; (5) relevant images and/or voice files (e.g., taken from a camera at the location where the incident happened); (6) a relevant map associated with the location of the device where the identification document is being scanned; and (7) a record of how the incident is resolved (e.g., suspect arrested) and related notes. In some embodiments, the incident report is generated using a suitable format or template, such in the format of a standard police investigation report. In some embodiments, the locations where the relevant images or voice files were generated, where certain scans happened, and/or where the incident was resolved can also be recorded and displayed on the relevant map.

Still another distinguishing feature of system 11 is that it includes an identification verification component 123. The identification verification component 123 is configured to verify the authenticity of the identification document. For example, the identification verification component 123 can check the format/content of the identification document and verify it by communicating with an internal database (e.g., information stored in the data storage unit 113) or an external database (e.g., the databases 119a or 119b). Additional details about techniques for verifying identification documents are described in commonly-owned U.S. Pat. No. 5,864,623, filed on Jul. 15, 1996 and entitled, “AUTHENTICATION SYSTEM FOR DRIVERS LICENSES,” U.S. Pat. No. 8,322,605, filed on Aug. 22, 2007 and entitled, “DYNAMIC IDENTITY MATCHING IN RESPONSE TO THREAT LEVELS,” U.S. Pat. No. 7,860,318, filed on Nov. 9, 2004 and entitled, “SYSTEM AND METHOD FOR COMPARING DOCUMENTS,” and U.S. Pat. No. 7,708,189, filed on May 16, 2003 and entitled, “IDENTIFICATION VERIFICATION SYSTEM AND METHOD,” which are incorporated by reference herein in their entirety.

To summarize, the system 11 provides a field operator with an alert that signifies a threat level of an individual and a recommended action by directly communicating with multiple databases to be searched. Also, the system 11 enables the field operator to access multiple databases to ensure robust search results. According to the search strategy of the field operator (e.g., involving a personal search or an item search), the system 11 can then determine proper databases to be searched. In some embodiments, the system 11 enables the field operator to select preferred databases to be searched such that the field operator can have a customized system that fits best to his/her role during field operations. In some embodiments, the system 11 searches multiple databases in a particular order (e.g., based on the system's default setting or the field operator's preferences). In other embodiments, the system 11 searches multiple databases in parallel. In order to implement the appropriate search strategy, the system maintains a table or other data structure containing a mapping of search strategies to databases. The mapping may include both system-generate search strategies/databases as well as user-specified search strategies/databases.

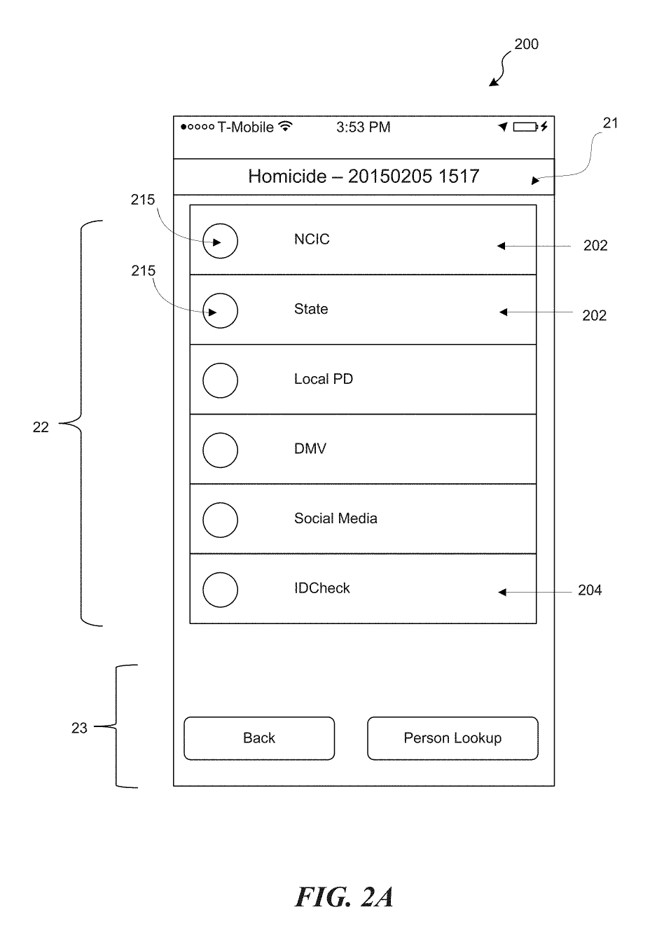

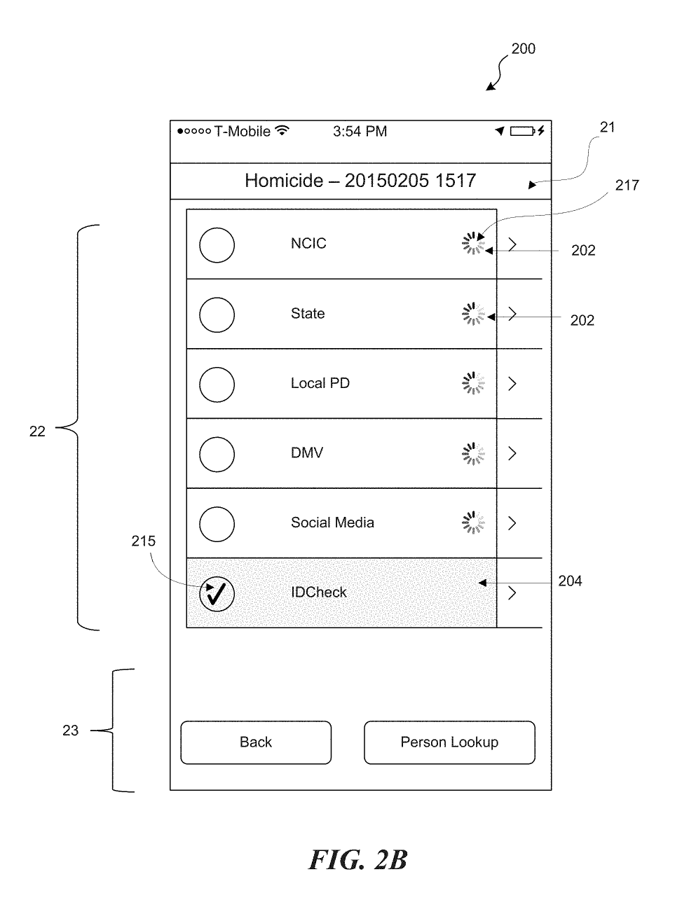

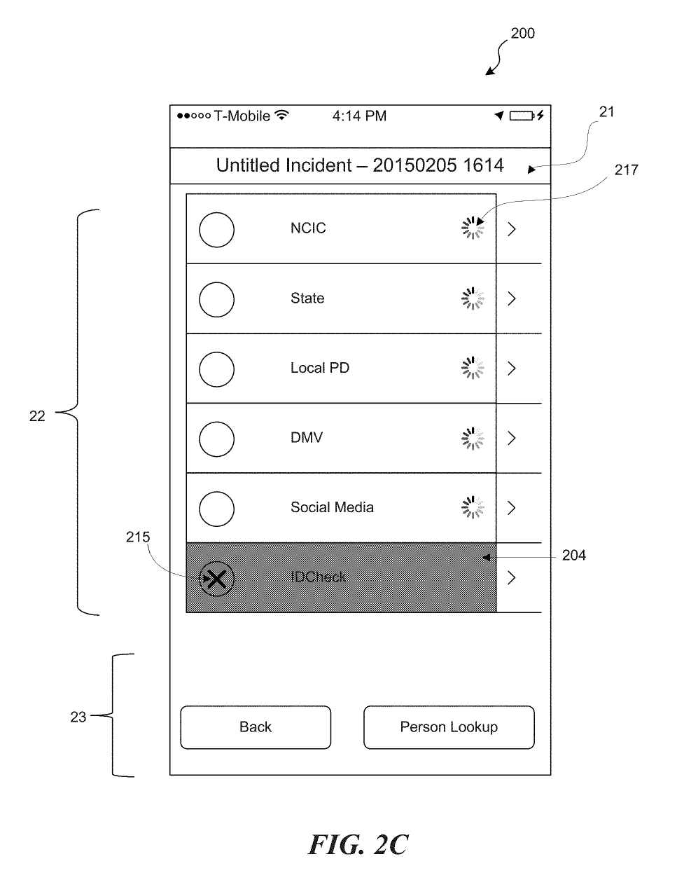

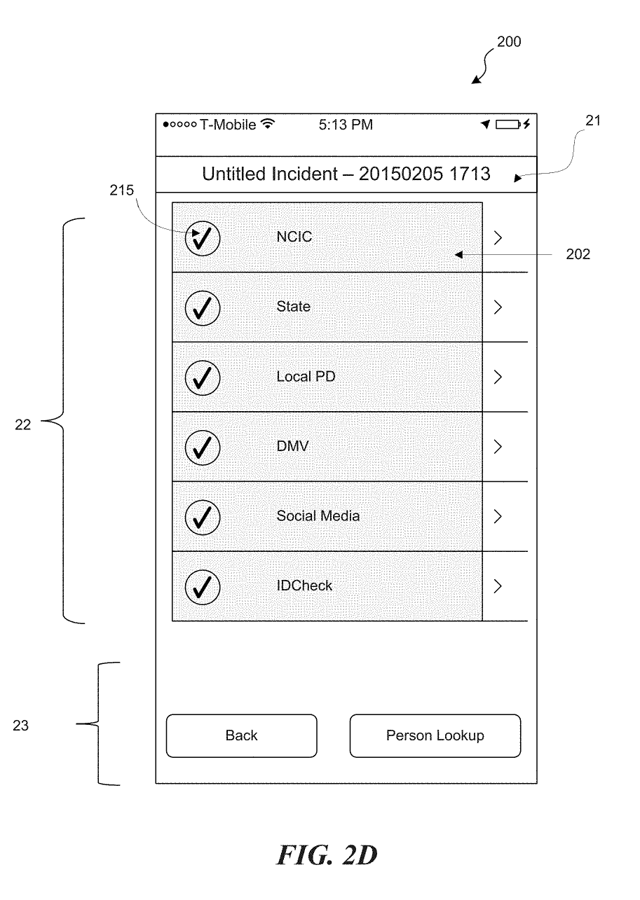

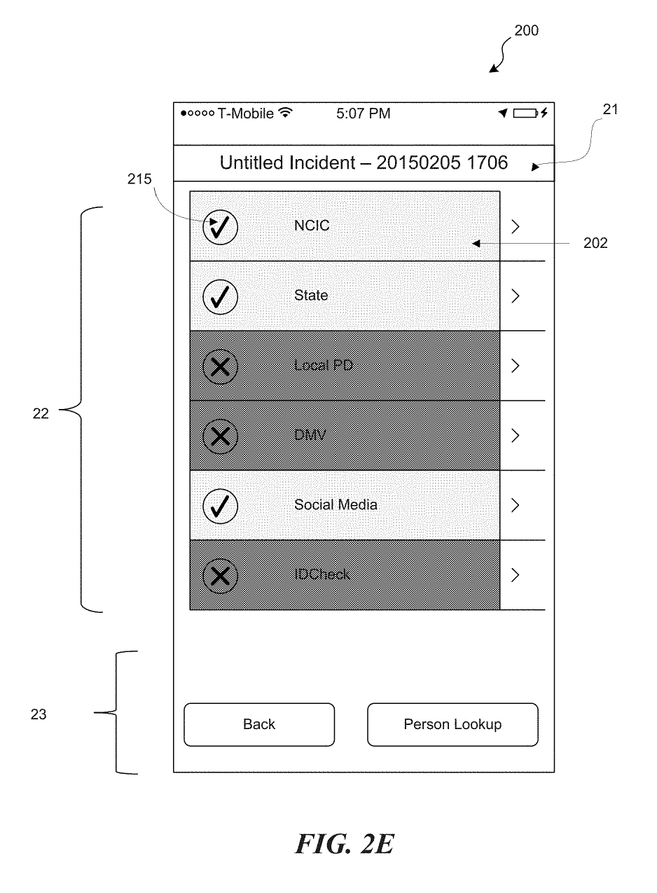

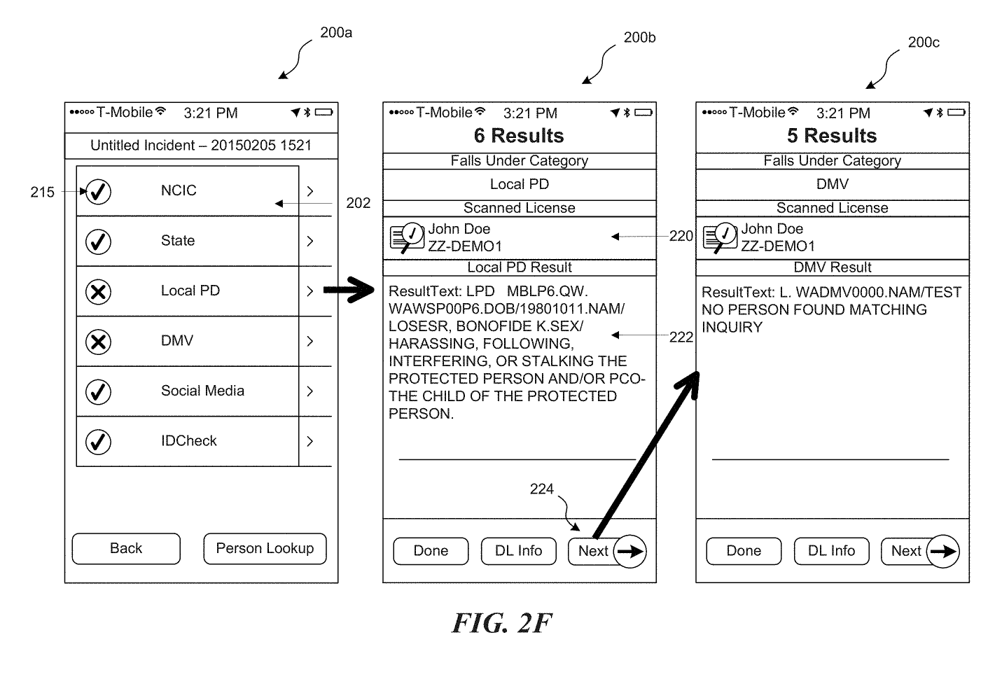

The presentation component 107 of the system generates multiple user interfaces which present an alert to a field operator or allow the operator to interact with the system. FIGS. 2A-4B are screenshots (and schematic diagrams with screenshots) illustrating representative user interfaces associated with the system. In addition, various embodiments of the alert discussed above are also illustrated in FIGS. 2A-2F. In these embodiments, the alert can include virtual buttons shown on user interfaces that are in various colors which represent different threat levels of an individual. One having ordinary skills in the relevant art should understand that the ways of presenting alerts are not limited to the depicted examples.

FIG. 2A depicts a user interface 200 that provides feedback to an operator of progress made towards analyzing data scanned from identification documents and associated with an incident. The user interface 200 includes a first region 21, a second region 22, and a third region 23. The first region 21 provides a brief summary of the incident being analyzed. The first region 21 includes a title associated with the incident (e.g., “Homicide”) and time of the incident (e.g., “20150205 1517,” in the format of YYYYMMDD TIME). The second region 22 includes a list of those databases that are to be searched by the system for that incident. Default databases to be searched are represented by tiles 202, with each tile having an associated database name on the tile. For example, the databases that will be searched for the incident depicted in FIG. 2A include an NCIC database, a State database, a local PD (police department) database, a DMV database, and a social media database. When initially presented to a user, all of the tiles are colored grey reflecting that the corresponding database has not yet been searched. As will be described in additional detail herein, progress in searching is represented by a change in color in the interface. Each tile also contains a status indicator field 215 which provides a quick visual indication to an operator as to whether any results were generated by the search query or queries to the corresponding database. In addition to a list of databases that are to be searched for the incident, the user interface 200 also indicates whether the scanned identification document is valid or not. The last tile 204 or the display (labeled “IDCheck”) is used to convey the validity of the scanned ID based on a check of appropriate databases. Additional details about techniques for verifying identification documents are described in commonly-owned U.S. Pat. No. 5,864,623, filed on Jul. 15, 1996 and entitled, “AUTHENTICATION SYSTEM FOR DRIVERS LICENSES,” U.S. Pat. No. 8,322,605, filed on Aug. 22, 2007 and entitled, “DYNAMIC IDENTITY MATCHING IN RESPONSE TO THREAT LEVELS,” U.S. Pat. No. 7,860,318, filed on Nov. 9, 2004 and entitled, “SYSTEM AND METHOD FOR COMPARING DOCUMENTS,” and U.S. Pat. No. 7,708,189, filed on May 16, 2003 and entitled, “IDENTIFICATION VERIFICATION SYSTEM AND METHOD,” which are incorporated by reference herein in their entirety.

It will be appreciated that the number and identity of databases reflected in the interface 200 will vary depending on the particular incident being investigated. Moreover, the number and identity of displayed databases may also vary depending on any system- or operator-defined preferences regarding databases to be searched. In the event that different databases were selected by the system or operator for searching, the databases would be reflected by different tiles 202.

To initiate a search of the listed databases, the operator presses a “Person Lookup” button shown in the third region 23. The “Person Lookup” button indicates that the system is going to perform a personal search strategy (e.g., queries relating to a person). The displayed button to initiate the search strategy is configurable based on an operator's search strategy preference. For example, if the operator wants to search an item (e.g., a gun), then the system replaces the “Person Lookup” button with an “Item Lookup” button or a “Gun Search” button. The field operator can also return to a welcome page or a menu page (not shown) by clicking a “Back” button shown in the third region 23.

FIGS. 2B and 2C are screenshots illustrating user interfaces 200 showing progress in analyzing the scanned identification document and in particular the results of an authenticity check for an identification document. The identification document is authenticated by checking the format/content of the presented identification document and comparing it with data contained in an internal database (e.g., information stored in the data storage unit 113) or an external database (e.g., the databases 119a, 119b, . . . 119n). Additional details about techniques for verifying identification documents are described in commonly-owned U.S. Pat. No. 5,864,623, filed on Jul. 15, 1996 and entitled, “AUTHENTICATION SYSTEM FOR DRIVERS LICENSES,” U.S. Pat. No. 8,322,605, filed on Aug. 22, 2007 and entitled, “DYNAMIC IDENTITY MATCHING IN RESPONSE TO THREAT LEVELS,” U.S. Pat. No. 7,860,318, filed on Nov. 9, 2004 and entitled, “SYSTEM AND METHOD FOR COMPARING DOCUMENTS,” and U.S. Pat. No. 7,708,189, filed on May 16, 2003 and entitled, “IDENTIFICATION VERIFICATION SYSTEM AND METHOD,” which are incorporated by reference herein in their entirety. The user interface 200 in FIG. 2B shows that the identification document has passed the authenticity check by the presence of a check mark or other affirmative tick symbol in the status indicator field 215. If the identification document passes the authenticity check, the IDCheck tile 204 is also displayed in a different color (e.g., green). In some embodiments, the different color and the check symbol can mean “normal,” “authentic,” or “no negative result found.”

In contrast, the user interface 200 in FIG. 2C depicts when the identification document has failed the authenticity check. When a document fails the check, an “X” or other negative indication is presented in the status indicator field 215. Moreover, the IDCheck tile 204 is also displayed in a different color (e.g., red), indicating the failure. By changing both the color of the tile and the indication in the status indicator field, the system allows a field operator to quickly make a visual assessment of success or failure.

Meanwhile, as shown in FIG. 2B, the second region 22 includes multiple symbols 217 corresponding to the tiles 202. The symbols 217 represent that the search of each of the corresponding databases is still currently pending. While pending, the tiles 202 continue to be presented in a neutral color such as yellow. In some embodiments, the field operator can choose to stop the database search process if the system determines that the identification document is invalid. In other embodiments, however, the database searches continue regardless of the outcome of the validity check.

FIGS. 2D and 2E are screenshots illustrating user interfaces 200 showing the results of the database searches. The user interface 200 in FIG. 2D shows that no negative results were found after performing the search in all listed databases. Moreover, the identification document also passed the authenticity check. As shown in FIG. 2D, each of the status indicator fields 215 can include a check mark or tick symbol. In addition, the tiles 202 can be displayed in one color, such as green. In the context of database queries, a check mark displayed by the system indicates that there were no negative search results returned from the database query. Based upon these visual cues, the field operator can quickly learn from the user interface 200 that the presented identification document is authentic and the identification document holder is likely not dangerous.

In contrast, the user interface 200 in FIG. 2E shows that several negative results were found as a result of the database searching. Moreover, the identification document failed to pass the authenticity check. As shown in FIG. 2E, those database queries that came back positive contain checkmarks and are displayed in one color, such as green. However, those database queries that came back with negative results include an “X” and the tiles 202 are displayed in a contrasting color, such as red. In some embodiments, the system presents an “X” if any negative search results are returned by the database query. In some embodiments, the system may assess the negative search query results and present an “X” when the results rise above a threshold level. For example, the different color and the “X” symbol can mean “dangerous” or “a high level of threat.” Based upon the presented visual cues, the field operator can learn from the user interface 200 that the presented identification document fails to pass the authenticity check and the identification document holder is likely dangerous.

FIG. 2F is a schematic diagram illustrating a sequence of user interfaces that depict how a field operator can review a database search result and learn additional information about the result of the search query. The user interface 200a depicts sample results of database searching, with positive results from three of the databases (NCIC, State, and Social Media) but negative results from two of the databases (local PD and DMV). The system enables the field operator to review search results by pressing or selecting any of the depicted tiles 202. When a database tile is selected, the system displays a user interface 200b to the operator that includes details about the database query. The user interface 200b includes a summary 220 of the scanned identification document and a description 222 of the query results received from the database. In the particular result displayed in user interface 200b, the system displays to the operator the results from the “Local PD” database query. The user may scroll vertically within the interface to view additional information about a selected result from the database query or to see additional results from the database query. By pressing a “next button” 224 located on the user interface 200b, the system displays another interface 200c that includes details about the results of the next database query or additional results of the same database query. For example, in the particular result displayed in user interface 200c, the system displays the results from the “DMV” database query. The user interface 200c includes a summary of the scanned identification document as well as a description of the results that were returned from the database query. In some embodiments, only those search queries that included database results are displayed to the operator. In other words, those search queries that did not return any results from the searched database are not displayed by the system to the operator. In some embodiments, the system can display a summary of the search results so as to provide the operator an overview of the search results. In some embodiments, the summary can include a short description such as “Found words: Homicide and Terrorist” or “No Alert Words Found.”

FIG. 3A is a schematic diagram illustrating an embodiment of an incident report 212 associated with an incident that is generated by the system and displayed on a mobile device of the field operator. The incident report includes details about an incident, including notes, comments, or photos generated by the field operator. As shown in FIG. 3A, the incident report 212 user interface includes a title 213, a description of the incident field 215, an incident start category 217 including the circumstances that caused the operator to capture the incident, an incident resolution category 219 specifying the ultimate action taken by the operator that concluded the incident (e.g., an arrest was made), an incident resolution note field 221 to allow the operator to include additional notes about the incident, a photo field 223, a query field 225, a scan field 227 including a list of identification documents that were scanned, and a voice memo field 228. The title 213 can include language indicative of the category of the incident (e.g., “Auto Theft”) as well as the time that the incident occurred (e.g., “20150205 1521”). The description of the incident field 215 is used by the field operator to provide an explanation or note regarding the nature of the incident (e.g., the incident pertains to a stolen car). The incident start category 217 is a category selected by the field operator reflecting (1) the type of violation that has occurred or (2) the cause of the field operator's initiation of the incident report. The incident resolution category 219 is a category selected by the field operator to describe (1) how the incident was resolved or (2) the field operator's response to the incident. By selecting the incident resolution category 219, the field operator is taken to a selection interface 220 that lists possible incident resolutions that the field operator can choose from. As shown in FIG. 3A, examples of the incident resolutions include: a physical arrest, generating an incident report without an arrest, evidence collection/submission, generating a follow-up report (e.g., describing leads for further investigation) or other types of reports (e.g., generate a Drug Enforcement Administration report; assign an updated incident code to the incident), an indication that the complaint (e.g., a phone call to a police station reporting a crime which leads to a further police investigation) is false or unfounded, etc. A selection of any of the displayed categories by the field operator causes the system to display the selected category on the incident report 212. In some embodiments, the system can provide similar selection interfaces for other incident report items such as the incident start category 217.

The incident report 212 also includes a number of fields that allow the field operator to capture or record data that is associated with the incident. For example, the incident report includes an incident resolution note field 221 that allows the field operator to include additional notes about the incident resolution (e.g., further details about the field operator's response to the incident). The system allows the field operator to enter notes using, for example, a virtual or physical keyboard or voice dictation. The incident report 212 contains a photo field 223 that allows a field operator to attach photographs taken of the incident to the incident report 212. When the system is implemented on a mobile phone, for example, the field operator may use a camera in the mobile phone to take pictures of an accident, crime scene, or to capture other pertinent images. The incident report also includes a voice memo field 228, which allows a field operator to record a voice memo that is associated with the incident.

In the incident report 212, the system also automatically displays the results of certain scanned or queried data that is associated with the incident. For example, in the scan field 227, the system indicates that a scan of a suspect's identification was performed and displays a portion of the scanned information (in the depicted example, the name of the individual scanned from the identification document). By selecting the scan field 227, the system displays an interface (not shown) which depicts more of the scanned information, such as the physical characteristics or image of the individual associated with the identification document, or any other associated information (e.g., a statement such as “there were two persons in a vehicle and both of them provided IDs to scan”). In the query field 225, the system indicates the number of queries that were performed by the system. By selecting the query field 225, the system displays an interface (not shown) with the queries and/or the result of the queries to the field operator.

FIG. 3B is a screenshot illustrating another embodiment of the incident report 212. Compared to the embodiment of the incident report described in FIG. 3A, the incident report 212 illustrated in FIG. 3B further includes an incident map 235. As shown in FIG. 3B, the incident map 235 can include various symbols thereon to indicate items such as the location where images were taken, the location of various incidents, the location where a voice memo was recorded, the location where an ID was scanned (e.g., when a suspect ran from a crime scene and was caught at another place where his ID was scanned), the location where certain notes were captured, etc.

It will be appreciated that the displayed fields in the incident report 212 of FIG. 3A or 3B are merely exemplary. Incident reports generated by the system may include a greater or lesser number of fields than are displayed.

FIG. 4A is a screenshot illustrating a user interface generated by the system that allows a field operator to select a role when using the system. As shown in FIG. 4A, the user interface includes a scrollable list 229 that includes various roles for the field operator to select. Examples of the roles include: a police officer, an investigator, a patrol officer, a border patrol officer, a security guard, a university officer, a federal agent, a custom role, etc. When a field operator selects a particular role, the system enables certain system configurations that are associated with that role. Each configuration may include different available database search queries, different formats of incident reports, etc. for that selected role. By selecting an “about” button, the configuration settings associated with that role can be displayed. Once a desired role is found in the scrollable list 229, the field operator selects the displayed role by selecting the “set role” button.

FIG. 4B is a screenshot illustrating a user interface generated by the system that allows a field operator to display an order of databases and to select session start categories for a “custom” role. As shown in FIG. 4B, the user interface includes an upper region 231 and a lower region 233. The upper region 231 displays a list of the databases to be searched. The list of databases to be searched includes a list of all available databases that will be searched based on the system operator's search query. The system allows the field operator to determine the display order of the databases by editing the order of the displayed list so that the databases are displayed with the most important database(s) to the field operator at the top. For example, the field operator can move a database higher in the list to give that database a higher priority. In contrast, movement of a database lower in the candidate list gives the database a lower priority. A higher priority can mean that (1) the field operator prefers to view a search result from a database with a higher priority; or (2) the field operator has more confidence in a database with a higher priority. In some embodiments, a higher priority can mean that the field operator wants to search a database with a higher priority when the number of databases that can be searched is limited (e.g., searching more databases can incur additional fees). In other embodiments, the field operator can adjust the priorities of the databases in other suitable ways. In some embodiments, the field operator may de-select databases to be searched in the upper region 231 if the field operator concludes that there is no value to querying a particular database during an incident.

The lower region 233 displays a list showing the order of incident codes that can be selected by the field operator when completing an incident report. In some embodiments, the incident codes may be displayed in order of frequency, in order of severity, or in another order. For example, the system allows a field operator to configure the system to display incident codes in a particular order (e.g., “010 Homicide,” “020 Rape,” “030 Robbery” etc.) in the Session Start Categories field.

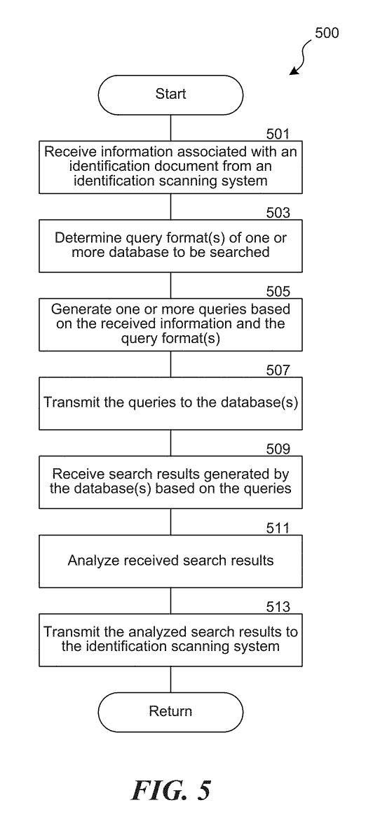

FIG. 5 is a flowchart illustrating a method 500 implemented by the query server 117 to search various databases based on information scanned from identification documents. The query server analyzes information derived from an identification document via the input component 103, and provides query responses to the system 10. At block 501, the query server receives all or a portion of information associated with the identification document and the operator's search query from the system 10. If the system does not have sufficient information from the identification document to complete the desired search query, the system can send a request to the field operator for further information. The field operator may respond to the request by either manual entry of the missing information or by scanning additional documents in order to generate the missing information.

The method 500 continues to block 503 where the query server determines one or more query formats of one or more databases to be searched. Query formats for multiple databases may be stored by the query server, and selectively retrieved when queries are to be made. A query format may include a database address as well as specific information about the API used to make calls to the database. At block 505, the query server generates one or more queries based on the received information, the system or system operator's search strategy, and the resulting necessary query format. At block 507, the query server transmits each generated query to the corresponding database. At block 509, the query server receives information generated by each database in response to the query. At block 511, the query server analyzes the integrity of the search results. For example, the query server may verify that search results were received from each database and that the received search results are in the expected format. The query server also analyzes the content of the search results and summarizes, truncates, or otherwise reformats the received information. For example, the query server may (1) examine the search results and identify the types of the search results (e.g., a name match during a personal search); and (2) determine whether the search results are positive or negative. In some embodiments, the query server can supplement the search results with summaries or additional information so as to simplify the display of the search result by the identification scanning system. The operation of the query server described in method 500 allows the system 10 to check the identity and characteristics of an individual or of an item by accessing various databases. At block 513, the query server transmits the responsive results to the identification scanning system.

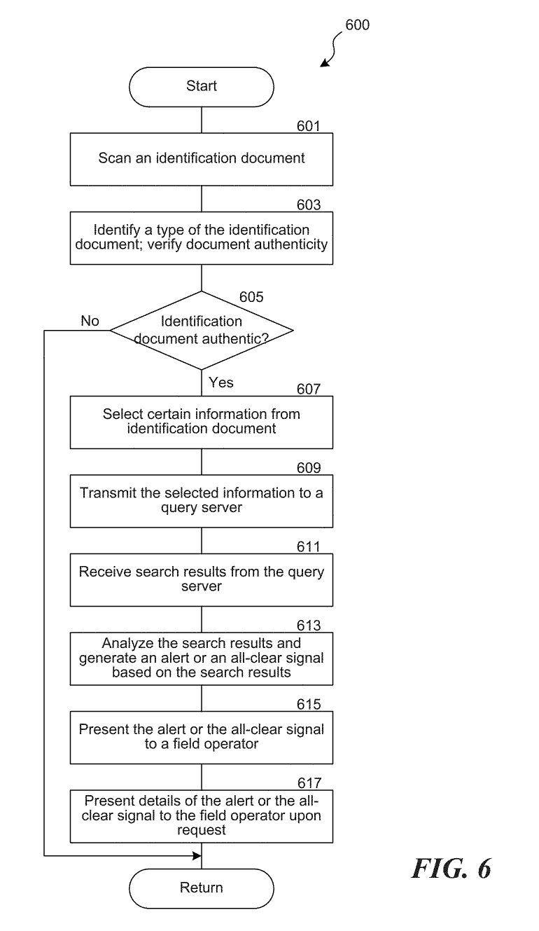

FIG. 6 is a flowchart illustrating a method 600 implemented by the system 10. The system analyzes information derived from an identification document of an individual and presents an alert to a user based on the analysis results. At block 601, a field operator uses the system to scan an identification document. The system identifies a type of the identification document and assesses the authenticity of the identification document at block 603. Additional details about techniques for verifying identification documents are described in commonly-owned U.S. Pat. No. 5,864,623, filed on Jul. 15, 1996 and entitled, “AUTHENTICATION SYSTEM FOR DRIVERS LICENSES,” U.S. Pat. No. 8,322,605, filed on Aug. 22, 2007 and entitled, “DYNAMIC IDENTITY MATCHING IN RESPONSE TO THREAT LEVELS,” U.S. Pat. No. 7,860,318, filed on Nov. 9, 2004 and entitled, “SYSTEM AND METHOD FOR COMPARING DOCUMENTS,” and U.S. Pat. No. 7,708,189, filed on May 16, 2003 and entitled, “IDENTIFICATION VERIFICATION SYSTEM AND METHOD,” which are incorporated by reference herein in their entirety. At decision block 605, the system assesses the results of the authenticity test. If the identification document is authentic at block 605, processing continues to block 607. If the identification document is not authentic at block 605, the method 600 finishes. In such circumstances, the system typically provides an alert (e.g., a colored tile shown on a user interface, such as the ID-Check tile 204 in FIG. 2C) to inform the user that the identification document is not authentic. In other embodiments, even if the identification document fails to pass the authentic test at block 605, the system can provide an alert or a flag to the system operator of the document's failure to pass the authentication check, but still continue to block 607.

At block 607, the system selects information scanned from the identification documents. The information can be all or part of the information retrieved from the identification documents. For example, the selected information can include a name, an identification number, a date of birth, an address, gender information, a height/weight, an eye color, an image, a signature, and/or other suitable information of the individual. Because the query server may access different databases, each containing different fields or types of information, the system will typically provide all scanned information that is necessary to the query server to facilitate the formulation of search queries. In some embodiments, the system determines whether the scanned information is sufficient to formulate the desired search queries. If the scanned information is insufficient, the system may send a request for further information to the operator. The operator can then manually input the missing information or scan additional documents in order to provide sufficient information to formulate the search queries.

At block 609, the system transmits the selected information and a search strategy to a query server. The selected information and search strategy may be encrypted or encoded prior to transmission to the query server. As discussed above, the search strategy can be automatically selected by the system based on the selected role of the field operator. In some embodiments, the system can make recommendations of the search strategy to the field operator based on the operator's prior interaction with the system. For example, the system can suggest a search strategy to a field operator appropriate for an auto-theft investigator if the field operator has scanned a vehicle title document. Alternatively, the search strategy may be selected by the field operator. The search strategy indicates which databases are to be searched by the query server. The search strategy may also include any limitations on the searches, such as keywords to use in the search, priorities of search, certain emphasis in search strategies, etc. Once the query server receives the selected information and the search strategy, it generates one or more queries to databases to be searched.

Upon receiving results that are responsive to the search query, the query server formats the results for delivery to the system. Formatting may include summarizing, coding, or otherwise interpreting the query results. In some embodiments, the query server waits until search results are received from all queried databases before transmitting the results to the system. In some embodiments, the query server transmits search query results to the system as the results are received from queried databases. The query server then transmits the search results to the system. The transmitted search results may be encrypted or encoded prior to transmission to the system.

At block 611, the system receives search results from the query server. As discussed above, in some embodiments, the search results can be generated by the query server. In some embodiments, the search results are directly routed back to the system from the database at which the search was performed.

At block 613, the system analyzes the search results and then generates an alert or an all-clear signal based on the search results. For example, the system can calculate a score based on the search results and use the score to determine a threat level of the individual. As previously discussed, the score may be based on an algorithm that determines the frequency of certain keywords within the search results. The system then generates an appropriate alert based on the calculated score, such as by assigning different colors to reflect different threat levels. In some embodiments, the system can form the alert based directly on information in the search results. For example, the search results might include a piece of information that indicates that the individual has outstanding warrants for the arrest of the subject. In such case, the system can directly translate the search results into an alert. For example, the system may generate a visual signal such as a flashing red light to indicate that the individual is a wanted suspect. The system may also generate an all-clear signal when the system determines that nothing atypical or suspicious was found in the search result. In some embodiments, the all-clear signal can be a green light. At block 615, the system presents the alert or the all-clear signal to the user. As previously discussed, the alert can be visually (e.g., a color shown on a display), audibly (e.g., through an earpiece), or tactilely (e.g., a vibration of a wearable item) presented to the user. In some embodiments, the alert includes not only a threat level of the individual but also a recommended action thereto. For example, an alert of a red light signal can mean that an individual is dangerous, while an alert of a flashing light signal can mean that the system recommends arresting the individual. Accordingly, when a user receives an alert of a red flashing light signal, he/she would know that the individual is dangerous and the recommended action from the system is to arrest that individual. At block 617, the system can present details of the alert or the all-clear signal to the user upon the user's request. For example, the details of the alert can include (1) details of the factors that caused the system to generate the alert, and (2) a list of the specific search results and the contents of those results. The method 600 then ends. In general, through the use of simple visual alerts, the system can effectively notify the user of the authenticity of the presented identification document, signify a threat level of the individual, and present a recommended action.

In some embodiments, the system can perform a series of database searches by treating initial search results from one database as input (e.g., as a search keyword) for subsequent searches to be automatically performed in other databases. The use of initial search results to formulate a subsequent search query will be referred to as a “follow-up” search. For example, the system can perform an initial personal search based simply on an individual's name in multiple databases including the DMV database. The result of the DMV search can include a driver's license number associated with the individual's name. The system can then use the driver's license number as part of a subsequent search query or queries in the same or different databases. A follow-up search is particularly useful in cases where the initial retrieved information conveys limited actionable information. Follow-up searches can be repeatedly performed by the system so as to maximize search results based on limited information retrieved from an identification document or collected by other suitable means. In some embodiments, the system can recommend to the field operator that an additional (follow-up) search should be performed. The recommendation may be based on certain pre-determined criteria. For example, if a previously unavailable database becomes available based on information that was received as a result of a prior search, the system may recommend a follow-up search within the database. In some embodiments, the system can make recommendations for follow-up searches based on empirical data. For example, the system can recommend performing a stolen car search associated with a car that an individual is driving, if initial search results indicate that the individual has a prior criminal record of auto theft.

It will be appreciated by those skilled in the relevant art that the components or units that are part of the system or interact with the system may be implemented by computer-executable instructions, such as program modules, executed by one or more computers or other devices. Those skilled in the art will further appreciate that the system or aspects of the system disclosed herein may be implemented on any computing system or device. Suitable computing systems or devices include server computers, multiprocessor systems, microprocessor-based systems, network devices, minicomputers, mainframe computers, distributed computing environments that include any of the foregoing, and the like. Such computing systems or devices may include one or more processors that execute software instructions to perform the functions described herein. Processors include programmable general-purpose or special-purpose microprocessors, programmable controllers, application specific integrated circuits (ASICs), programmable logic devices (PLDs), or a combination of such devices. Software may be stored in a memory, such as a random access memory (RAM), a read-only memory (ROM), a flash memory, or a combination of such devices. Software may also be stored in one or more storage devices, such as magnetic or optical based disks, flash memory devices, or any other type of non-volatile storage medium for storing data. Software may include one or more program modules which include routines, programs, objects, components, data structures, and so on that perform particular tasks or implement particular data types. The functionality of the program modules may be combined or distributed as desired in various embodiments.

From the foregoing, it will be appreciated that specific embodiments of the system have been described herein for purposes of illustration, but that various modifications may be made without deviating from the spirit and scope of the system. Accordingly, the present technology is not limited except as by the appended claims.

We claim:

1. A method for analyzing information derived from an identification document associated with an individual, the method comprising:
receiving information associated with an identification document from an identification scanning system, the identification document associated with an individual of interest;
receiving an indication of a search strategy for the received information, wherein the search strategy indicates an identity of databases that are to be searched;
maintaining query formats associated with a plurality of databases;
generating search queries to two or more of the plurality of databases that are indicated by the search strategy, the search queries based on the received information and the associated query formats of the two or more databases;
transmitting the search queries to the two or more databases;
receiving responses to the search queries from the two or more databases;
analyzing the received responses to generate information characterizing a status of the individual; and
transmitting the information characterizing the status of the individual of interest to the identification scanning system, wherein the identification scanning system uses the information characterizing the status of the individual to present an alert to an operator of the identification scanning system that reflects a threat level of the individual.

2. The method of claim 1, wherein the received information is derived from a scan of the identification document by the identification scanning system or from manual input from the operator, and wherein the method further comprises verifying the authenticity of the identification document.

3. The method of claim 1, wherein the alert includes a visual indication displayed on a display of the identification scanning system.

4. The method of claim 3, wherein:
the alert comprises a first color to indicate when the threat level is higher than or equal to a threshold level; and
the alert comprises a second color to indicate when the threat level is lower than the threshold level.

5. The method of claim 3, wherein:
the alert comprises a first color to indicate when the threat level is higher than or equal to a threshold level;
the alert comprises a second color to indicate when the threat level is lower than the threshold level; and
the alert comprises a third color to indicate when the threat level is still being assessed.

6. The method of claim 3, wherein:
the alert includes a first color to indicate that the individual has a threat level higher than or equal to a first threshold level;
the alert includes a second color to indicate that the individual has a threat level lower than a second threshold level; and
the alert includes a third color to indicate that the individual has a threat level lower than the first threshold level and higher than or equal to the second threshold level.

7. The method of claim 1, further comprising generating an incident report, wherein the incident reports includes one or more of:
an indication of the transmitted search queries; and
an action taken by the operator in response to the alert.

8. The method of claim 1, further comprising generating an incident report, wherein the incident reports includes one or more of:
a time period that the received information is received;
a location that the received information is received;
an incident description;
an incident category;
an voice memo; and
an image.

9. The method of claim 1, wherein the search strategy is based on a role of the operator.

10. The method of claim 1, further comprising:
assigning priorities to the two or more databases; and
transmitting the search queries to the two or more databases in a sequence that is based on the assigned priorities.

11. The method of claim 1, further comprising:
requesting additional information associated with the identification document when the received information is insufficient to generate the search queries.

12. A method for displaying information derived from an identification document associated with an individual to a user of an identification scanning system, the method comprising:
scanning the identification document;
identifying a type of the identification document, the identification document associated with an individual of interest;
receiving information associated with the identification document;
receiving an indication of a search strategy for the received information, wherein the search strategy indicates an identity of databases that are to be searched;
transmitting the information associated with the identification document and the indication to a server, so as to enable the server to generating search queries to two or more of the plurality of databases that are indicated by the search strategy, wherein the search queries is associated with query formats of the two or more databases maintained by the server;
receiving response information from the server, wherein the response information is generated based on a search performed by the server, and wherein the search is performed based on the search queries; and
visually presenting an alert to the user through a display of the identification scanning system, wherein the alert is indicative of a threat level of the individual.

13. The method of claim 12, wherein the search performed by the server includes a keyword search.

14. The method of claim 12, wherein the query formats of the two or more databases query include query languages required by the two or more databases.

15. The method of claim 12, wherein:
the alert includes a first alert, with a first color, to indicate that the threat level is higher than or equal to a threshold level; and
the alert includes a second alert, with a second color, to indicate that the threat level is lower than the threshold level.

16. The method of claim 12, wherein:
the alert includes a first alert, with a first color, to indicate that the threat level is higher than or equal to a threshold level;
the alert includes a second alert, with a second color, to the user to indicate that the threat level is lower than the threshold level; and
the alert includes a third alert, with a third color, to indicate that the threat level is to be determined.

17. The method of claim 12, wherein the alert includes a summary of the response information.

18. The method of claim 12, wherein:
the alert includes a first alert, with a first color, to indicate that the individual is with a threat level higher than or equal to a first threshold level;
the alert includes a second alert, with a second color, to indicate that the individual is with the threat level lower than a second threshold level; and
the alert includes a third alert, with a third color, to indicate that the individual is with the threat level lower than the first threshold level and higher than or equal to the second threshold level.

19. The method of claim 12, further comprising generating an incident report, wherein the incident reports includes one or more of:
the search queries; and
an action taken by the user in response to the alert.

20. The method of claim 12, further comprising generating an incident report, wherein the incident reports includes one or more of:
a time period that the received information is received;
a location that the received information is received;
an incident description;
an incident category;
an voice memo; and
an image.

21. The method of claim 12, further comprising generating an incident report, wherein the incident reports includes one or more of:
a time period that the first set of information is received;
a location that the first set of information is received; and
an action taken by the user in response to the alert.

22. A system for displaying identification information from an identification document to a user, the system comprising:
a processor;
a memory coupled to the processor;
an input component configured to receive input information from the identification document;
a search component configured to process the input information, wherein the search component generates a query for a database based on a pre-determined search strategy, wherein the search strategy indicates an identity of databases that are to be searched;
a transmitting component configured to transmit the query to the database;
a receiving component configured to receive response information from the database, wherein the response information is generated based on a search in the database, and wherein the search is performed based on the query;
a data storage unit configured to store the input information and the response information; and
a display module configured to display an alert indicative of a status of an item or an individual associated with the identification document to the user, wherein the alert is generated based on the response information.

23. The system of claim 22, further comprising:
a report component configured to generate an incident report; and
an identification verification component configured to verify authenticity of the identification document.

24. The system of claim 22, wherein:
the display component is further configured to generate an user interface so as to present the alert to the user;
the alert includes a first alert, with a first color, to indicate that the threat level is higher than or equal to a threshold level and a second alert, with a second color, to indicate that the threat level is lower than the threshold level.

25. The system of claim 22, wherein the input component enables the user to manually input additional information when the input information is insufficient to generate the query.
